(19) United States
(12) Patent Application Publication
(10) Pub. No.: US 2021/0359371 A1
(43) Pub. Date: Nov. 18, 2021

(54) BATTERY THERMAL MANAGEMENT BY COOLANT DISPERSION

(71) Applicant: Electric Power Systems, Inc., North Logan, UT (US)

(72) Inventor: Randy Dunn, Orange, CA (US)

(73) Assignee: Electric Power Systems, Inc., North Logan, UT (US)

(21) Appl. No.: 17/285,869

(22) PCT Filed: Oct. 4, 2019
(86) PCT No.: PCT/US19/54870

§ 371 Date: Apr. 15, 2021

Related U.S. Application Data
(60) Provisional application No. 62/745,737, filed on Oct. 15, 2018.

(51) Int. Cl. H01M 50/317; H01M 50/207; H01M 50/375; H01M 10/6567

(52) U.S. Cl. CPC H01M 50/317; H01M 10/6567; H01M 50/375; H01M 50/207

(57) ABSTRACT

Electrochemical cell battery systems and associated methods of operation are provided based on the incorporation of a thermal suppression construct including a supply of an electrically non-conductive hydrofluoroether dispensed directly to and in intimate contact with one or more cells disposed within a sealed enclosure should that one or more cells attain an unsafe thermal state. Excessive heat generated by the one or more cells causes the fluid to boil, generating vapor that removes heat from the one or more cells and ventilates outside of the sealed enclosure through a valve.

### CROSS REFERENCE TO RELATED APPLICATIONS

This application claims priority to U.S. Provisional Application Ser. No. 62/745,737 filed on Oct. 15, 2018 and entitled “BATTERY THERMAL MANAGEMENT BY COOLANT DISPERSION,” the disclosure of which, is incorporated herein by reference to the extent such disclosure does not conflict with the present disclosure.

### TECHNICAL FIELD

The present disclosure relates generally to a battery, and, more particularly to a secondary battery comprised of a plurality of electrochemical or electrostatic cells.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A secondary battery is a device consisting of one or more electrochemical or electrostatic cells, hereafter referred to collectively as “cells”, that can be charged electrically to provide a static potential for power or released electrical charge when needed. The cell is basically comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Other types of cells include capacitors, which can come in the form of electrolytic, tantalum, ceramic, magnetic, and include the family of super and ultra-capacitors. Such cells are mass produced, driven by an ever-increasing consumer market that demands low cost rechargeable energy for portable electronics. Energy density is a measure of a cell's total available energy with respect to the cell's mass, usually measured in Watt-hours per kilogram, or Wh/kg. Power density is a measure of the cell's power delivery with respect to the cell's mass, usually measured in Watts per kilogram, or W/kg. Both energy density and cost are critical metrics of the value of traction batteries as documented in “Lithium-ion Batteries for Hybrid and All-Electric Vehicles: the U.S. Value Chain”, edited by Marcy Lowe, Saori Tokuoka, Tali Trigg and Gary Gereffi, said teaching incorporated here by reference.

In order to attain the desired operating voltage level, cells are electrically connected in series to form a battery of cells, which is typically referred to as a battery. In order to attain the desired current level, cells are electrically connected in parallel. When cells are assembled into a battery, the cells are often electrically linked together through metal strips, straps, wires, bus bars, etc., that are welded, soldered, or otherwise fastened to each cell to link them together in the desired configuration.

Secondary batteries are often used to drive traction motors in order to propel electric vehicles. Such vehicles include electric bikes, motorcycles, cars, busses, trucks, trains, and so forth. Such traction batteries are usually large with hundreds or thousands or more individual cells linked together internally and installed into a case to form the assembled battery.

Failure modes of such cells include an exothermic event, also known as thermal runaway. This feature makes the use of such cells highly dangerous in certain applications, such as onboard aircraft, vehicles, or in medical applications. Common causes of thermal runaway include over charge, external short circuit, or internal short circuits. Over charge and external short circuits can be prevented by use of fuses and over voltage disconnect devices. However, such devices are ineffective at preventing internal short circuits since there is no practical way to stop shorts across the substantially large anode to cathode interface internal to the cell. Positive thermal coefficient devices are sometimes installed inside cells for convenience and improved security, but the positive thermal coefficient devices are still unable to stop anode to cathode internal shorts since they reside outside of that circuit. Circuit interruption devices, whether mechanical or electronic can protect against over charge, but since they are also outside the anode to cathode circuit, they are unable to do anything to protect against internal shorts.

Thermal events pose a substantial threat to the aforementioned traction batteries given the large number of cells each contains. The probability of a thermal event increases with the number of cells, as does the potential for thermal event cascade to other cells within the battery, resulting in an increase in the overall impact potential of the event. Accordingly, some form of thermal runaway mitigation is beneficial to the overall safety of the battery.

A novel solution of having the cells immersed in an electrically non-conductive hydrofluoroether fluid has been shown to mitigate thermal runaway, without the need for pumps or other complex apparatus requiring maintenance or prone to failure, is taught in publication number US 2009/0176148 A1. This patent application discloses the immersion of batteries into a container filled with a heat transfer fluid, and containing a heat exchanger at least partially filled with the heat transfer fluid. The fluid is a liquid or gas, and preferably a heat transfer fluid such as a hydrofluoroether (HFE) that has a low boiling temperature, e.g. less than 80° C. or even less than 50° C. The vaporization of this fluid contributes to the heat removal from the immersed batteries.

HFEs are available, for example, under the trade designation NOVEC Engineered Fluids (available from 3M Company, St. Paul, Minn.) or VERTREL Specialty Fluids (available from DuPont, Wilmington, Del.). Particularly useful HFEs for embodiments within the aforementioned patent include NOVEC 7100, NOVEC 7200, NOVEC 71 IPA, NOVEC 71DE, NOVEC 71DA, NOVEC 72DE, and NOVEC 72DA, all available from 3M. As described in the above mentioned patent application, cells immersed within said fluid do not go into thermal runaway due to the vaporization of the fluid. Immersing a cell in a fluid is effective at heat removal at temperatures well below cell ignition point. This has been demonstrated to be true, despite repeated short circuit attempts using standard practices known to normally induce such events.

A disadvantage of this approach to improving the safety of batteries is the reliance on gas and/or liquid as the transfer fluid. HFEs in particular are very slippery materials, and gas or liquids within the battery pack case are prone to escape upon any opening being formed in the case, such as by impact or through direct permeation. In some instances, a reservoir may be added to mitigate losses of material through the case over time. The reservoir provides a backup to the coolant that escapes over time. This also has the added benefit of providing additional coolant into the battery when needed.

One disadvantage to both of these approaches is in the mass of the material required to implement such solutions in large scale traction batteries. The amount of fluid required to fulfill these designs is substantial since the entire battery is full of the coolant, and there is even more coolant mass carried in the described coolant pool. HFEs are very heavy, typically twice the mass density of water. This is very disadvantageous for traction batteries since the batteries typically already comprise a large portion of the vehicle overall mass. As stated above, the gravimetric energy density is a critical metric to the value of traction batteries.

Another disadvantage to the use of so much material is its cost. Typically, HFEs cost around US $60/kg. Although US 2009/0176148 does not disclose specifically the amount of fluid used in the comparative examples, it does state that the cells are immersed. Immersion of the cells is assumed to be at least 20% of the cell volume. The A123 cell used in the experiment has a density of 1.7 kg/l, and the HFE has a density of 2 kg/l. Based on this assessment, simply flooding a large traction battery of 100 kWh in energy comprising A123 cells has a mass of 951 kg and requires 223 kg of coolant. This is a 23% mass overhead compared to the cells alone. The coolant would further cost US $13,425 at 2018 prices, and compared to the cell cost of US $30,000, that is a 44% cost overhead compared to the cells alone. As cited above, the overall cost is a critical metric to the value of traction batteries.

### SUMMARY

The following presents a simplified summary in order to provide a basic understanding of some aspects of one or more embodiments of the present teachings. This summary is not an extensive overview, nor is it intended to identify key or critical elements of the present teachings nor to delineate the scope of the disclosure. Rather, its primary purpose is merely to present one or more concepts in simplified form as a prelude to the detailed description presented later.

In an embodiment of the present teachings, a battery system can include a sealed housing having one or more isolated internal cavities. One or more battery cells are deposed within each of the isolated internal cavities. A continuous internal conduit runs throughout the sealed housing feeding into each of the one or more isolated internal cavities and simultaneously connected to a pressurized reservoir containing a non-electrically conductive hydrofluoroether (HFE) fluid. Each of the one or more isolated internal cavities includes at least one thermal sensitive actuator that is within thermal proximity to the one or more battery cells. Each of the one or more isolated internal cavities includes at least one exhaust vent. If any of the one or more cells within one of the isolated internal cavities heats sufficiently it enables the at least one thermal sensitive actuator to open, thereby releasing the non-electrically conductive HFE fluid contained within the continuous internal conduit and pressurized reservoir such that the fluid floods around the cells within the isolated internal cavity. The HFE cools the one or more battery cells by phase change, vaporization, causing the pressure to increase, thereby forcing ventilation through the at least one exhaust vent, releasing and suppressing the thermal event.

### BRIEF DESCRIPTION OF THE DRAWINGS

The accompanying drawings, which are hereby incorporated into and constitute a part of this specification, illustrate embodiments of the present disclosure and, together with the description, serve to explain the principles of the invention. In the drawings, wherein like reference numerals represent like parts:

FIG. 1 illustrates a top view of an assembled battery, in accordance with an example embodiment; and

FIG. 2 illustrates a method of preventing a thermal runaway event, in accordance with an example embodiment.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

From the forgoing, it will be apparent to the reader that one important and primary object of the present disclosure resides in the provision of a novel method to prevent thermal runaway of an electrochemical cell or group of cells. The disclosure has the advantage of having an automatic response mechanism based on cell temperature and has reduced mass and financial impact as compared to the prior art.

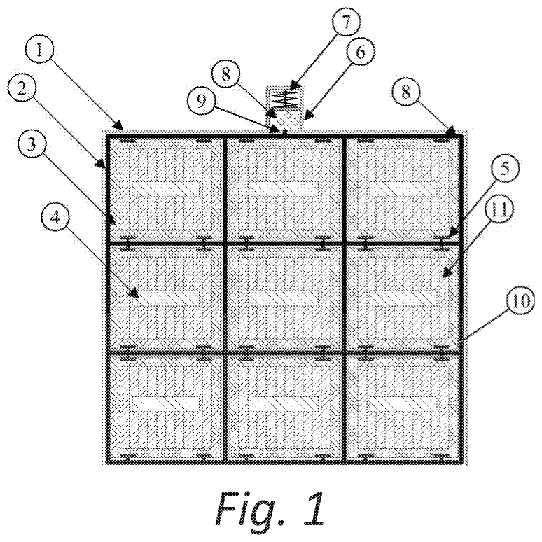

Referring now to FIG. 1, a proposed battery solution comprises a sealed enclosure 1 capable of housing one or more internal cavities 3 that are isolated from one another such that liquid or gas cannot move from one cavity to another. The enclosure may be made from a wide variety of materials capable of be providing the mechanical support for the cells and having the ability to be completely sealed. Various plastics, including Acrylonitrile butadiene styrene (ABS), and metals, including aluminum and steel, are suitable materials for the sealed enclosure 1.

The sealed enclosure 1 also features a continuous internal conduit 2 throughout its structure. The conduit is routed to each of the one or more internal cavities 3. The conduit is coupled to each of the one or more internal cavities 3 through at least one dispensing port 10. The conduit is constructed such that a fluid 8 pushed into it will pass into all of the cavities through at least one dispensing port 10 during an emergency condition. An emergency condition occurs when a battery cells 11 temperature exceeds its operating temperature, indicating that a thermal runaway event is likely to occur. The at least one dispensing port 10 is sized to allow sufficient heat transfer fluid 8 to pass in respect to the size of the cavity. The at least one dispensing port 10 are sealed to prevent passage of any fluid 8 by a thermally sensitive valve 5 during normal operation.

In one example embodiment, the one or more thermally sensitive valves 5 can be a simple plug made from a metal that melts at a desired temperature. Suitable metals include eutectic or fusible alloys with low melting points, including alloys of lead, bismuth, and tin and commonly known by names like Wood's Metal, Rose Metal, and Lipowitz's Alloy. Such metals are used in fire sprinkler valves, preventing pressurized water from exiting a pipe until triggered by heat, at which time the alloy softens sufficiently to release a sealing plug. The one or more thermally sensitive valves 5 can alternatively comprise a heat-sensitive glass bulb, also used in fire sprinkler valves. As with the alloy, the glass bulb is designed to break as a result of thermal expansion as it heats up, thereby opening the seal that restricts the coolant. Moreover, any other thermally sensitive valve 5 construction may be used that opens to fluid flow in response to heat rising above a designated level. The size, location, and number of the one or more thermally sensitive valves 5 are driven by the specific geometry of the internal cavities 3, and may be located on the top, bottom, or side of the internal cavity or any combination thereof. For an example embodiment, the temperature of a cell that may trigger the melting of a thermally sensitive valve 5 would be a cell exceeding 70 deg C., or in another embodiment a cell exceeding 90 deg C. In another example embodiment, the temperature of the thermally sensitive valve 5 that may trigger the melting of the thermally sensitive valve 5 would be the valve exceeding 65 deg C., or in another embodiment the valve exceeding 85 deg C. The triggering condition varies based on the type of cell used and can therefore be a wide range of temperatures based on design need, and the level of safety required.

A heat transfer fluid 8, such as a hydrofluoroether (HFE) that has a low boiling temperature, e.g. less than 80° C. or even less than 70° C., may be dispensed within the continuous conduit. In an alternative embodiment, the heat transfer fluid 8 may be supplied externally from the sealed enclosure 1 by being released during an emergency condition. In an example embodiment, the coolant is configured to begin to boil at a temperature that is towards the high operating range of the battery cells 11. Examples of material classes for the heat transfer fluid 8 are highly-fluorinated compounds used commercially for cleaning electronic components. Commercial examples of suitable coolants include the 3M™ Novec™ Engineered Fluids family of products, sold under the trade names HFE-7100, HFE-7200, and others. HFE-7100 has a boiling point of 61 deg C., which is highly compatible with many commercial electrochemical cells that have peak operating temperature range of 65 deg C.

One or more reservoirs 6 can be connected to the conduit through one or more access ports 9. These one or more reservoirs 6 can contain additional heat transfer fluid 8 to supplement the coolant dispersed within the continuous conduit. In another example embodiment, the reservoirs 6 may contain the primary source of the heat transfer fluid 8, and the reservoir(s) may release the heat transfer fluid 8 into the continuous conduit during an emergency condition. The one or more reservoirs 6 can also provide additional pressurization to enhance the flow of heat transfer fluid 8 through the conduit. Examples of such pressurizing reservoirs 6 are spring-loaded piston cylinders 7, elastic inflatable bladders, or simply gravity fed.

The one or more internal cavities 3 incorporates one or more vent ports 4. The vent ports 4 may comprise a disc or plate of eutectic or fusible alloy or a pressure sensitive burst disc or similar construct. The size and location of the one or more vent ports 4 are driven by the specific geometry of the internal cavities 3, and may be located on the top, bottom, or side of the internal cavity or any combination thereof. In an example embodiment, the vent ports 4 are located at the top of the internal cavities 3 to allow the vapor to naturally escape during an emergency condition.

Disposed within each of the internal cavities 3 are one or more battery cells 11. In the diagrammatic example, ten pouch type cells are shown. Alternatively, the battery cells 11 may be of prismatic type or cylindrical type of construction, all are equally compliant with the present disclosure. The battery cells 11 can be connected in series or parallel or a combination of series and parallel. Electrical connections can be made, in an example embodiment, by soldering and/or welding, and with battery straps or bus bars of aluminum or copper or similar metals well known to those skilled in the art. External connections to the battery cells 11 can be made, for example, through one of the walls in the internal cavity by electrically conductive feedthroughs. The battery cells 11 are packaged so as to be proximate to the thermally sensitive valve 5. This will allow the heat generated during a thermal runaway event to open the thermally sensitive valve 5 and permit a heat transfer fluid 8 to flow into the internal cavities 3. For example, each cell of a battery pack may be close enough such that a single cell is essentially the same temperature as the thermally sensitive valve 5. In another example embodiment, the thermally sensitive valve 5 may be located in multiple locations around an internal cavity of the internal cavities 3 with the intent of minimizing the distance to the furthest cell in an internal cavity of the internal cavities 3.

Operation of the present disclosure is triggered when one or more battery cells 11 heats up beyond the actuation point of the thermally sensitive valve 5. When this happens, the pressurized heat transfer fluid 8 in the conduit and optional reservoir is released to flood into that specific internal cavity, leaving the other internal cavities 3 unaffected. The result of the heat transfer fluid 8 flooding into the cavity is to remove the heat from the battery cells 11 through phase change vaporization of the heat transfer fluid 8. As the pressure and/or heat increases, the vent port opens and releases the resulting gas from the vaporization of the heat transfer fluid 8. The surface of the one or more battery cells 11 is kept at the vaporization temperature of the heat transfer fluid 8 and thermal runaway is prevented since the battery cell cannot attain the ignition temperature point. The heat transfer fluid 8 is not electrically conductive, non-flammable and has no flash point. This is a very critical aspect as many heat transfer fluids other than water, such as various oils, ethylene glycol, polypropylene glycol, among many others, have flash points that are well below the thermal runaway temperature of the battery cells 11. Such materials exhibit violent combustion of the coolant once the battery cells 11 reach thermal runaway temperatures, and thus magnifying the destructive force of the event.

The benefits the disclosure offers are substantial mass reductions since the amount of coolant required is sized to just a portion of the battery system. This is in sharp contrast to flooding all cells in the battery system in thermal transfer fluid, which significantly increases mass overhead and provides no greater safety than the present disclosure. The novel approach takes advantage of the low likelihood that more than one cell would suffer an internal short resulting in a potential thermal event at any one time in a large battery. The failure rate of modern cells is 0.1 ppm, or 10e-7. These odds indicate that one cell may suffer a thermal event given a long period of time in a battery system with a large number of battery cells 11, but the odds drop to 10e-14 for two such cells suffering a thermal event at the same time. Therefore, it is virtually impossible that two cells would suffer the same fate simultaneously in such a system. As the present disclosure has the capability to defuse a single cell thermal event with a very small amount of heat transfer fluid 8 specifically targeted at the event location, it provides an optimized solution that is a significant improvement.

Thus, in an example embodiment, a battery comprises a thermal runaway suppression system safeguarded by a phase change vaporization fluid, wherein the total amount of fluid is 0.2-1× the volume of an internal cavity. In another example embodiment, the total amount of fluid is 1-2× the volume of an internal cavity for a system with ten to hundreds of cavities. In another example embodiment, the total amount of fluid is 2-3× for a system with less than ten cavities.

Another aspect of the present disclosure is reduced battery volume. Separation of battery cells 11 is a common practice for mitigating thermal propagation. But such separation is not trivial in order to be reliable and results in a larger heavier battery. The present disclosure also reduces battery volume and mass further in that the separation of battery cells 11 can be very small. It is also possible, as described, to place more than one cell into each cavity. Although only one cell is likely to suffer a thermal event, the other cells will be minimally affected due to the heat transfer fluid 8 dispensed throughout the shared cavity.

Thus, in an example embodiment, a battery comprises a thermal runaway suppression system safeguarded by a phase change vaporization fluid, wherein the additional volume of the heat transfer fluid 8 safeguarding the battery is 1-10% of the total volume of the internal cavities 3 of the battery. More preferably, the additional volume of the heat transfer fluid 8 safeguarding the battery cells 11 is 1-5% of the total volume of the internal cavities 3 of the battery. In another example embodiment, the additional volume of the heat transfer fluid 8 safeguarding the battery cells 11 is 3-5% of the total volume of the internal cavities 3 of the battery. Thus, in an example embodiment, a battery comprises a thermal runaway suppression system safeguarded by a phase change vaporization fluid, wherein the additional mass of the heat transfer fluid 8 safeguarding the battery is 1-10% of the mass of the battery if there were no safeguarding heat transfer fluid 8. More preferably, the additional mass of the heat transfer fluid 8 safeguarding the battery cells 11 is 1-5% of the mass of the battery if there were no the heat transfer fluid 8 safeguarding the battery cells 11. In another example embodiment, the additional mass of the heat transfer fluid 8 safeguarding the battery cells 11 is 3-5% of the mass of the battery if there were no heat transfer fluid 8 safeguarding the battery cells 11. The greatest mass and volume savings are in large systems comprising hundreds of internal cavities 3.

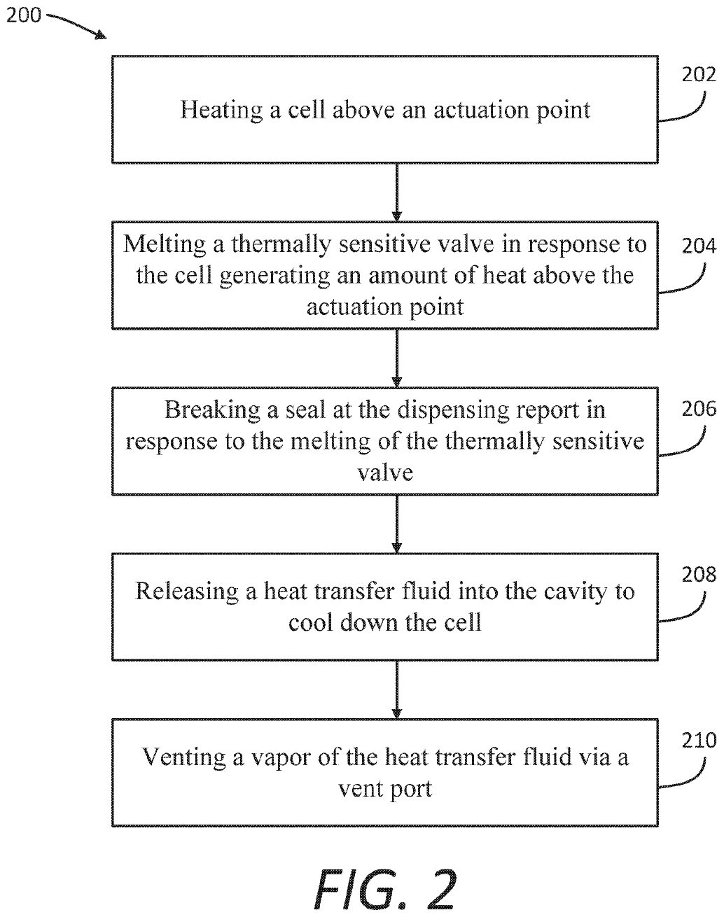

Referring now to FIG. 2, a method of preventing a thermal runaway event, in accordance with an example embodiment, is illustrated. The method comprises heating a cell above an actuation point (step 202). This may occur as a cell enters thermal runaway as described herein. The method further comprises melting a thermally sensitive valve in response to the cell generating an amount of heat above the actuation point (step 204). The method further comprises breaking a seal at the dispensing port in response to the melting of the thermally sensitive valve (step 206). The method further comprises releasing a heat transfer fluid into the cavity to cool down the cell (step 208). In an example embodiment, the heat transfer fluid may be disposed in a conduit coupled to the thermally sensitive valve. In another example embodiment, the heat transfer fluid may be disposed in a reservoir outside the conduit and the heat transfer fluid may be released into the conduit in response to the melting of the thermally sensitive valve. In an example embodiment, the heat transfer fluid may be pressurized to enhance the flow of the heat transfer fluid through the conduit. The method may further comprise venting a vapor of the heat transfer fluid via a vent port (step 210).

A battery system is disclosed herein. The battery system may comprise a plurality of cavities and common reservoir. Each cavity in the plurality of cavities may comprise a plurality of cells. Each cavity in the plurality of cavities may be in fluid communication with a thermally sensitive valve. The common reservoir may be connected to a respective cavity in the plurality of cavities via an internal conduit in fluid communication with each respective thermally sensitive valve. The battery system may be configured for cooling thermal runaway in one of the cells in the plurality of cells in a respective cavity by vaporization cooling.

In various embodiments, each cavity may further comprise a vent. The common reservoir may be configured to provide a passive cooling system, wherein the reservoir is pressurized when thermal runaway occurs in a cell in a respective plurality of cells. The common reservoir may contain sufficient fluid to prevent thermal runaway in no more than one of the cavities in the plurality of cavities.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: 1 at least one of A; 2 at least one of B; 3 at least one of C; 4 at least one of A and at least one of B; 5 at least one of B and at least one of C; 6 at least one of A and at least one of C; or 7 at least one of A, at least one of B, and at least one of C.

What is claimed is:

1. A battery system comprising:
a sealed enclosure;
a cavity within the sealed enclosure, the cavity comprising a plurality of cells;
an internal conduit routed to the cavity, the internal conduit having a dispensing port;
a thermally sensitive valve creating a seal between the internal conduit and the cavity.

2. The battery system of claim 1, further comprising a plurality of cavities, the plurality of cavities including the cavity.

3. The battery system of claim 2, further comprising a plurality of dispensing ports, the plurality of dispensing ports including the dispensing port, each dispensing port fluidly coupled to a respective cavity in the plurality of cavities and the internal conduit.

4. The battery system of claim 3, further comprising a plurality of thermally sensitive valves, the plurality of thermally sensitive valves including the thermally sensitive valve, each thermally sensitive valve coupled to a respective dispensing port in the plurality of dispensing ports.

5. The battery system of claim 1, further comprising a heat transfer fluid dispensed within the internal conduit.

6. The battery system of claim 2, further comprising a pressurizing reservoir having an access port coupled to the internal conduit, wherein the pressurizing reservoir is in fluid communication with the plurality of cavities via the internal conduit.

7. The battery system of claim 6, wherein the pressurizing reservoir is configured to pressurize a heat transfer fluid to enhance a flow of heat transfer fluid through the internal conduit during a thermal runaway event.

8. The battery system of claim 2, further comprising a source of a heat transfer fluid, wherein the source and the heat transfer fluid are located outside of the cavity during non-thermal runaway operation.

9. The battery system of claim 8, wherein the heat transfer fluid is only provided to a respective cavity of the plurality of cavities, that comprise cells that are experiencing thermal runaway.

10. The battery system of claim 9, wherein the heat transfer fluid has a fluid volume between 1 and 10% of a total volume of the plurality of cavities.

11. The battery system of claim 9, wherein the heat transfer fluid has a fluid mass between 1 and 10% of a mass of the battery system without the heat transfer fluid.

12. A method for preventing a thermal runaway event, the method comprising:
melting a thermally sensitive valve due to a cell generating an amount of heat above an actuation point of the thermally sensitive valve proximate the cell, the thermally sensitive valve being coupled to a dispensing port;
breaking a seal at the dispensing port due to the melting of the thermally sensitive valve; and
releasing a heat transfer fluid into a cavity to cool down the cell.

13. The method of claim 12, wherein the heat transfer fluid is released from a reservoir in response to the melting of the thermally sensitive valve.

14. The method of claim 13, wherein releasing the heat transfer fluid further comprises pressurizing the heat transfer fluid to enhance a flow of heat transfer fluid through an internal conduit.

15. The method of claim 12, further comprising venting a vapor of the heat transfer fluid via a vent port.
